(19) United States
(12) Patent Application Publication
(10) Pub. No.: US 2025/0355948 A1
(43) Pub. Date: Nov. 20, 2025

(54) INSTRUCTION-BASED DUAL ENCODER RETRIEVAL SYSTEM

(71) Applicant: Google LLC, Mountain View, CA (US)

(72) Inventors: Fedor Moiseev, Zurich (CH); Zhe Dong, Zurich (CH)

(21) Appl. No.: 18/668,065

(22) Filed: May 17, 2024

(51) Int. Cl. G06F 16/903

(52) U.S. Cl. CPC G06F 16/90335

(57) ABSTRACT

Methods, systems, and apparatus, including computer programs encoded on a computer storage medium, for selecting a data item output in response to a query for a particular task using neural network and training one or more of the neural networks to generate one or more data item embeddings. In one aspect, a method comprises applying a learned adapter to a query embedding to generate an adapted query embedding for a new query for the particular task and selecting, as a relevant target data item for the new query, one or more of the target data items using the adapted query embedding for the new query and a target embedding for the target data items. In another aspect, a method comprises training an adapter using adapted query embeddings, positive target embeddings, and negative target embeddings for a plurality of fine-tuning examples while keeping a pre-trained query encoder neural network fixed.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a method for selecting a data item output in response to a query for a particular task by processing the query using neural networks and a method for training one or more of the neural networks.

According to a first aspect, there is a method by one or more data processing apparatus that includes maintaining a respective target embedding for each of multiple target items; receiving a new query for a particular task; processing the new query using a query encoder neural network to generate a query embedding of the new query; applying a learned adapter for the particular task to the query embedding to generate an adapted query embedding for the new query for the particular task; and selecting, as a relevant target data item for the new query, one or more of the target data items using the adapted query embedding for the new query and the target embedding for the target data items.

In some implementations, each target data item includes text, an image, a video, an audio signal, or a combination thereof, and the new query includes text, an image, a video, an audio signal, or a combination thereof.

In some implementations, the method further comprises generating the respective target embedding for each of the multiple target items, and the generating includes processing the target item using an item encoder neural network to generate an initial target item embedding of the target item.

In some implementations, generating the respective target embedding further includes applying the learned adapter for the particular task to the initial target item embedding to generate an adapted target item embedding.

In some implementations, selecting the one or more of the target data items includes performing a search to identify one or more target items that have target item embeddings that are closest to the adapted query embedding according to a similarity measure.

According to a second aspect, there is a method by one or more data processing apparatus that includes obtaining data specifying a pre-trained query encoder neural network, obtaining fine-tuning data for a particular task, the fine-tuning data including multiple fine-tuning examples, each fine-tuning example including a fine-tuning query, a positive target data item, and a negative data item, and training an adapter for the particular task, the training including, for each of the multiple fine-tuning examples, processing the fine-tuning query using the pre-trained query encoder neural network to generate a query embedding of the fine-tuning query; applying the adapter for the particular task to the query embedding to generate an adapted query embedding for the fine-tuning query for the particular task, obtaining a positive target embedding for the positive target data item, and obtaining a negative target embedding for the negative target data item, and training the adapter using the adapter query embeddings, the positive target embeddings, and the negative target embeddings for the fine-tuning examples while keeping the pre-trained query embedding neural network fixed.

In some implementations, obtaining the positive target embedding for the positive target data item and obtaining the negative target embedding for the negative target data item includes processing the positive target data item and the negative data item using a pre-trained item encoder neural network to generate the positive target embedding for the positive target data item and the negative target embedding for the negative target data item.

In some implementations, processing the positive target data item and the negative data item includes applying the adapter for the particular task to the positive target embedding and the negative target embedding to generate an adapted positive target embedding and an adapted negative target embedding.

In some implementations, training the adapter using the adapted query embeddings, the positive target embeddings, and the negative target embeddings for the fine-tuning examples while keeping the pre-trained query embedding neural network fixed includes training the adapter using the adapted query embeddings, the positive target embeddings, and the negative target embeddings for the fine-tuning examples while keeping the pre-trained query embedding neural network and the pre-trained target embedding neural network fixed.

In some implementations, obtaining fine-tuning data for a particular task includes, for each fine-tuning example, processing the fine-tuning query of the fine-tuning example using a language model to generate a respective positive target data item and a respective negative target data item of the fine-tuning example.

In some implementations, processing the fine-tuning query of the fine-tuning example using the language model to generate the respective positive target data item and the respective negative target data item of the fine-tuning example includes processing an input that includes the query and a prompt that instructs the language model to generate a positive target data item according to a specification for the particular task using the language model.

In some implementations, processing the fine-tuning query of the fine-tuning example using the language model to generate the respective positive target data item and the respective negative target data item of the fine-tuning example includes processing a second input that includes the query and a prompt that instructs the language model to generate a negative target data item according to the specification for the particular task using the language model.

In some implementations, training the adapter using the adapted query embeddings, the positive target embeddings, and the negative target embeddings for the fine-tuning examples includes training the adapter on a loss function that comprises a contrastive loss. In some implementations, the loss function further comprises a regularization loss.

In some implementations, the method includes, prior to the training, initializing the adapter as an identity transformation. In some implementations, the adapter is a projection matrix, and applying the adapter includes multiplying the query embedding by the projection matrix, and the training includes updating entries of the projection matrix.

In some implementations, the positive target data item is a correct item to be selected given the fine-tuning query, and the negative target data item is an incorrect item that should not be selected given the fine-tuning query.

In some implementations, the positive target data item and the negative data item each include text, an image, a video, an audio signal, or a combination thereof, and the fine-tuning query includes text, an image, a video, an audio signal, or a combination thereof.

The subject matter described in this specification can be implemented in particular embodiments so as to realize one or more of the following advantages.

A user can submit a query to a system, and the system can retrieve an output in response to the query by using one or more neural networks to process the query. For example, a user can submit the query to a search engine that retrieves one or more data items based on the query. The system can retrieve the output that is the “most relevant” for the query by selecting from multiple data items, such as text, audio, video, or a combination.

In conventional approaches, the system selects the relevant data item output by using an encoder to generate embedding representations of the data items and performing a search of the embedding representations according to one or more algorithms. However, conventional approaches may not be as effective in retrieving an output for a relatively highly specialized task in comparison to a more generalized task. In particular, conventional systems may be unable to efficiently and accurately select an embedding that represents a particular aspect of relevance, rather than simply selecting a most relevant embedding, especially when only a relatively small amount of training data is available for the specialized task. For example, a user may query a system to retrieve positive relevant information (e.g., positive reviews) or negative relevant information about an item, rather than retrieving general relevant information about the item, and the system may not be able to accurately retrieve a positive review about the item based on the generated query embedding, e.g., if the neural network(s) have been trained on a relatively small amount of training data for the positive review retrieval task.

In contrast, this specification describes techniques that allow for training a system to retrieve outputs for a relatively highly specialized task using a relatively small amount of training examples based on applying and training an adapter. These techniques allow a system to train an adapter to generate adapted embeddings by processing embedding outputs of a pre-trained encoder. In some examples, the system can train the adapter to generate query embeddings, embeddings of one or more data items, or both.

In some examples, the system can use one or more prompts to cause a language model to generate additional training examples for the specialized task for use in training the adapter, further improving the ability of the system to perform the specialized task with only limited amounts of original training data.

Once trained, the system can leverage the adapter and pre-trained encoders to efficiently extract useful information from the embedding outputs for selecting the output in response to the query. In some examples, the system can implement the adapter to generate an adapted embedding for the query embedding. In some other examples, the system can implement the adapter to generate adapted embeddings for the query embeddings and the data item embeddings. Therefore, by leveraging the pre-trained encoder to train an adapter using a relatively small amount of training examples, the system can implement the trained adapter to more accurately retrieve a relevant output in response to a query for a highly specialized task. Additionally, the system can train multiple different adapters for different specialized tasks while using the same pre-trained encoder for each of the adapters, which allows the system to perform multiple different specialized tasks in a computationally efficient manner.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a block diagram of an example training system.

FIG. 3 is a flow diagram of an example process for selecting a data item output in response to a query for a particular task by processing the query using an encoder neural network and an adapter neural network.

FIG. 4 is a flow diagram of an example process for training one or more neural networks to generate data item embeddings and to select the data item output from the generated data item embeddings.

Like reference numbers and designations in the various drawings indicate like elements.

### DETAILED DESCRIPTION

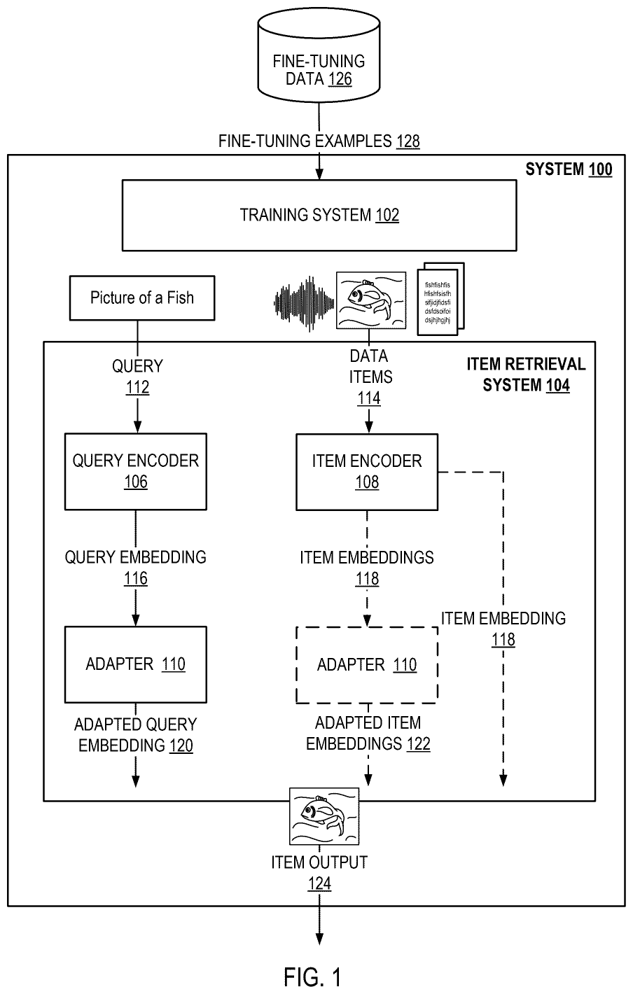

FIG. 1 shows an example system 100. The system 100 is an example of a system implemented as computer programs on one or more computers in one or more locations in which the systems, components, and techniques described below are implemented.

The system 100 is configured to retrieve a data item output that includes one or more data items in response to a query for a particular task. The system 100 is configured to retrieve the data item output (e.g., item output 124) that includes one or more data items 114 that are most relevant to the query 112. The one or more data items 114 can be any variety of data items, such as a text document, an image, a video, or an audio signal.

The system 100 includes a training system 102 and an item retrieval system 104. The item retrieval system 104 is configured to the item output 124 including one or more data items in response to the query 112. The item retrieval system 104 includes a query encoder 106 configured to generate a query embedding 116 by processing the query 112, an item encoder 108 configured to generate an item embedding 118 by processing each of the data items 114, and an adapter 110 (e.g., a trained adapter 110) configured to generate an adapted embedding by processing a query embedding, an item embedding, or both.

In particular, the system 104 uses the item encoder 108 to generate multiple item embeddings 118 each corresponding to a target data item 114. The item embedding 118 can be an ordered collection of numeric values (e.g., a vector or matrix of floating point or other numeric values that represents the target data item 114). The item encoder 108 can be any appropriate neural network that can map a data item of a particular type to an embedding. For example, the item encoder 108 can be a Transformer, a convolutional neural network, a vision Transformer, or a recurrent neural network.

The system 104 stores the item embeddings 118 in a data structure that is configured to allow the item embeddings 118 to be searched. For example, the data structure can be an index. In some examples, the system 104 can use the adapter 110 to generate respective adapted item embeddings 122 by processing each of the item embeddings 118. The system can then store the adapted item embeddings 122 using the data structure.

The system can then receive the query 112. In particular, the query 112 can be a new query submitted by a user of the system. For example, a user can submit the query 112 by inputting the query into a user interface. In some examples, the query can be a query for a general retrieval task of a relevant output. For example, the query can be “Picture of a Fish.” In some other examples, the query can be a query for a relatively specialized retrieval task of a particular relevant output, such as whether the data item is positive or negative or the length/size of the data item. For example, the query can be “Positive Review of Donuts” or “Long Description of Donuts.”

The system can generate a query embedding 116 by processing the query 112 using the query encoder 106. The query embedding 116 can be an ordered collection of numeric values (e.g., a vector or matrix of floating point or other numeric values that represents the query 112). The query encoder 106 can be any appropriate neural network that can map the query to an embedding. For example, the query encoder 106 can be a Transformer, a convolutional neural network, a vision Transformer, or a recurrent neural network. The query encoder 106 can be pre-trained jointly with the item encoder 108 (e.g., through contrastive learning or another appropriate representation learning task).

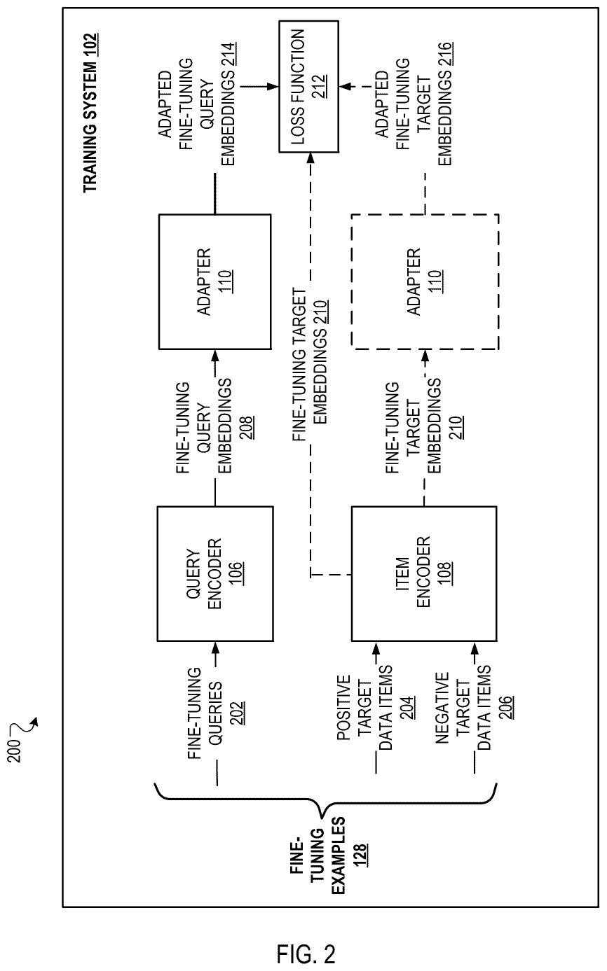

The system can generate an adapted query embedding 120 by processing the query embedding 116 using the adapter 110. The adapter 110 is configured to generate an adapted embedding that is specialized for the particular task, which allows the item retrieval system 104 to select the item output 124 by more accurately evaluating relevance for the particular task. Advantageously, the system can train the adapter 110 on a relatively small amount of training data, as described in further detail with reference to FIG. 2.

In some implementations, the adapter 110 can be a single linear layer (e.g., a projection matrix). In this case, the system can apply the adapter 110 by multiplying the generated embedding (e.g., the query embedding 116, the one or more item embeddings 118, or both) by the projection matrix, where the adapted embedding is the product of the embedding and the projection matrix. For example, the system can apply the adapter 110 to the query embedding 116 by multiplying the query embedding 116 by the projection matrix in order to generate the adapter query embedding 120. In some other implementations, the adapter can be of a different architecture, such as a multi-layer neural network architecture (e.g., a multi-layer perceptron).

Based on the adapted query embedding 120, to the system 100 can select one or more target embeddings that correspond to one or more relevant data items 114. The target embeddings can be the item embeddings 118, the adapted item embeddings 122, or both. In particular, the system can perform the search to identify one or more item embeddings 118 or one or more adapted item embeddings 122 each corresponding to a target data item 114 that are closest to the adapted query embedding 120 according to the similarity measure. For example, the system can perform a k-nearest neighbor search or an approximate x-nearest neighbor search of the item embeddings 118 to find the item embedding 118 that is closest to the adapted query embedding 116. In another example, applying the adapter 110 to both the item embeddings and the query embeddings can be particularly useful for specialized clustering tasks.

In conventional systems, a system performs a search to identify one or more item embeddings 118 each corresponding to a target data item 114 that are closest to the query embedding 116 according to a similarity measure. For example, the system can perform a k-nearest neighbor search of the item embeddings 118 to find the item embedding 118 that is closest to the query embedding 116. However, these techniques may not result in the system selecting the most relevant data items for a relatively highly specialized task. For example, in the case where a user provides a query of “Positive Review of Donuts,” or, in general, text including a positive review of an item, the system may output a negative review of the item (e.g., “these donuts are not good”) because the item embedding 118 associated with the negative review is similar to the query embedding 116, regardless of particular aspects of relevance (e.g., whether the review is a good review or a bad review). By making use of the adapter 110 to “adapt” the query embedding and, optionally, the item embeddings, the system 100 can efficiently extract useful information from the query embeddings, and optionally, the item embeddings in response to the query, which can be particularly useful for responding to a query for a highly specialized task.

The system can then generate (e.g., retrieve) the data output 124 including the one or more corresponding relevant data items 114 for the particular task. Thus, the item retrieval system 104 can more accurately retrieve the item output 124 based on implementing the trained adapter 110.

Prior to using the adapter 110 to adapt embeddings, the training system 102 is configured to train the adapter 110 to generate the adapted embeddings by processing the item embeddings, the query embeddings, or both. The training system trains the adapter 110 using fine-tuning examples 128 from fine-tuning data 126, as described in further detail below with reference to FIG. 2. The fine-tuning data 126 includes multiple fine-tuning examples 128, where each fine-tuning example includes a fine-tuning query, a positive target data item, and a negative target data item.

FIG. 2 is a block diagram of an example training system, e.g., the training system 102 described with reference to FIG. 1.

The training system 102 can train the adapter 110 to generate adapted embeddings in order for the item retrieval system 104 to select a relevant output item in response to a query using the trained adapter. In particular, the training system 102 trains the adapter 110 to generate the adapted embeddings on a contrastive loss function using the fine-tuning examples 128.

The training system 102 includes the pre-trained query encoder 106, the pre-trained item encoder 108, and the adapter 110 for fine-tuning using the loss function 212.

The system can use the pre-trained encoders (e.g., the item encoder and the query encoder) to generate fine-tuning embedding representations by processing the fine-tuning examples for training the adapter 110.

In particular, each of the fine-tuning examples 128 include a fine-tuning query 202, a positive target data item 204, and a negative target data item 206. The positive target data item 204 can be a correct answer to the query 202 for the particular task (e.g., a data item that the system should retrieve in response to the query), and the negative target data item 206 can be a wrong answer to the query 202 for the particular task (e.g., a data item that the system should not retrieve in response to the query).

For example, for a specialized task of retrieving positive reviews for an item, the fine-tuning query 202 can be “bagels,” the positive target data item 204 can be text that states “the best bagels in town!” and the negative target data item 206 can be text that states “these bagels are terrible.” As another example, for a specialized task of retrieving a long review for an item, the fine-tuning query 202 can be “pizza,” the positive target data item 204 can be text that states “this pizza is hand-crafted to perfection using the best brick oven available on the market,” and the negative target data item 206 can be text that states “good pizza.”

The training system 102 can use the query encoder 106 to generate a respective fine-tuning query embedding 208 from each of the fine-tuning queries 202 of the fine-tuning examples 128. The training system 102 can use the item encoder 108 to generate respective fine-tuning target embeddings 210 for each of the positive target data items 204 and the negative target data items 206 of the fine-tuning examples 128.

Prior to training, the training system 102 can initialize the projection matrix of the adapter 110 as an identity matrix, such that the initial adapted embeddings at the beginning of training are the same as the original embeddings. During fine-tuning, the training system 102 can apply the adapter 110 to the fine-tuning query embeddings 208 to generate the adapted fine-tuning query embeddings 214 by multiplying the projection matrix by each fine-tuning query embedding 208. In some examples, the training system 102 can apply the adapter 110 to the fine-tuning target embeddings 210 to generate the adapted fine-tuning target embeddings 216.

The system can then train the adapter 110 on the loss function 212 by updating the entries of the projection matrix using the fine-tuning embeddings while keeping the pre-trained query encoder and the pre-trained item encoder fixed. In this case, the training system 102 updates the projection matrix using the loss function 212 based on the updated entries of the projection matrix increasing the accuracy of performing the specialized task. The loss function is based on similarities between the query and the target embeddings.

In particular, the loss function 212 can be the contrastive loss function of Equation 1:

$${L}_{c} = \frac{{e}^{s i m ( q , {a}_{c} )}}{{e}^{sim ( q , {a}_{c} )} + {e}^{sim ( q , {a}_{w} )}} \qquad ( 1 )$$

where q is the fine-tuning query embedding 208, a_{c} is the positive fine-tuning target embedding 210, and a_{w} is the negative fine-tuning target embedding 210. In some examples, based on applying the adapter to the fine-tuning target embeddings 210, a_{c} is the adapted positive fine-tuning target embedding 216, and a_{w} is the adapted negative fine-tuning target embedding 216.

Based on the query embedding and the target embeddings, the system can compute a similarity matrix A, where Ai;j is a value that represents how similar the query embedding is to the particular target embedding. For example, Ai;j can be the dot product between the query embedding and a positive target embedding.

The system can train the adapter using gradients of the contrastive loss computed using the matrix A. For example, the contrastive loss can be the cross-entropy loss on the rows and columns of A. In some cases, prior to computing the matrix A, the system normalizes the query embedding and the target embeddings.

As this loss is minimized, for each of the fine-tuning examples, the query embeddings and the target embeddings become closer together while becoming farther from all other embeddings of the fine-tuning examples, thereby achieving the goal of the contrastive learning.

In some examples, the loss function 212 includes the contrastive loss function and a regularization loss of Equation 2:

$${L}_{w} = {L}_{c} + {α}_{w} {‖ adapter . W - E ‖}^{2} \qquad ( 2 )$$

where adapter·W is the projection matrix of the adapter 110, E is an identity matrix of the same size as the projection matrix, and α_{w} is a regularization component weight. The regularization component weight can penalize (e.g., discourage) the adapter from generating adapted embeddings that deviate from the original embeddings, allowing the adapted embeddings to accurately represent the original embedding for the particular task.

After training the adapter 110, the system 104 can apply the adapter 110 to the query embeddings, the item embeddings, or both during inference.

In some examples, the system can generate some or all of the fine-tuning examples 128 for training the adapter 110 by prompting a large language model (LLM). In particular, for each new fine-tuning example, the system can provide an input to the LLM that includes a fine-tuning query 202 and a prompt that instructs the LLM to generate a positive target data item 204 and a negative target data item 206 for the particular task. For example, for the specialized task of retrieving positive reviews for an item, the system can provide an input that includes the fine-tuning query 202 of “pizza”, a prompt that states “write a positive review of pizza,” and a prompt that states “write a negative review of pizza.” In some other cases, the system can provide separate inputs for the positive target data item 204 and the negative target data item 206.

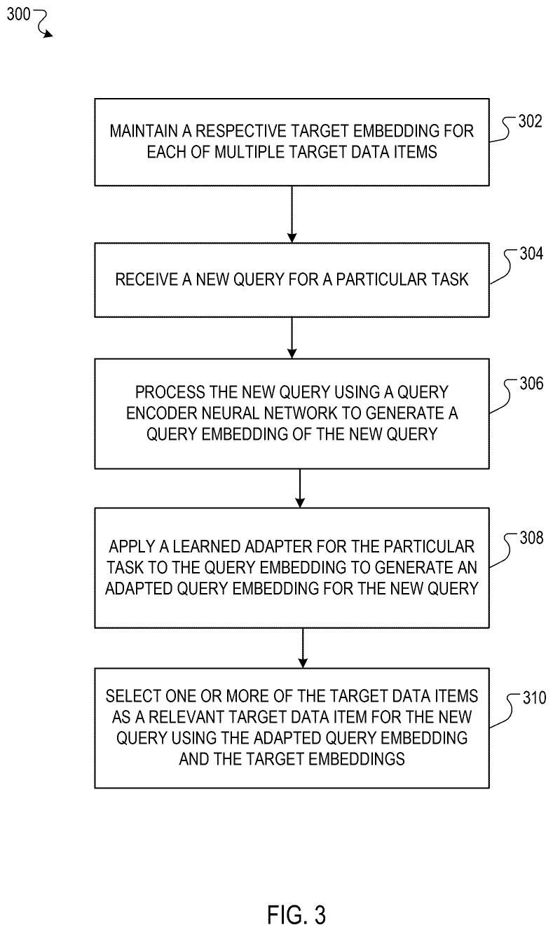

FIG. 3 is a flow diagram of an example process 300 selecting a data item output in response to a query for a particular task by processing the query using an encoder neural network and an adapter neural network. For convenience, the process 300 will be described as being performed by a system. For example, a system, e.g., the item retrieval system 104 of FIG. 1, appropriately configured in accordance with this specification, can perform the process 300.

The system can maintain a respective target embedding (e.g., a target item embedding) for each of multiple target data items (302). The target data items can be text, images, videos, audio signals, or a combination. For example, the target data items can be extracted from a database, from the Internet, or both.

In some examples, the system can generate a respective target embedding for each of the target items by processing the target item using an item encoder neural network to generate an initial target item embedding of the target item. In some cases, the target embeddings are initial embeddings generated by the pre-trained item encoder. In some other cases, the system can apply the adapter to the initial item embeddings to generate the target item embeddings.

The system can receive a new query for a particular task (304). For example, a user can submit a query for a particular task, such as a search for a particular data item. The query can include text (e.g., in the form of a question), images, video, audio signals, or a combination.

The system can process the new query using a query encoder neural network to generate a query embedding of the new query (306).

The system can apply a learned adapter for the particular task to the query embedding to generate an adapted query embedding for the new query (308). In some examples, the system can apply the learned adapter for the particular task to each target item embedding to generate an adapted target item embedding. The learned adapter has been trained on fine-tuning data for the particular task while keeping the query encoder and the item encoder fixed.

The system can select one or more of the target data items as a relevant target data item for the new query using the adapted query embedding and the i embeddings (310). In particular, the system can generate the data item output based on selecting the one or more data items. The system can be configured to generate a data item output that includes the top k most relevant data items.

For example, the system can select one or more target data items as the most relevant target data items in response to the new query based on processing the target embeddings. In particular, the system can perform a search to identify one or more target items that have corresponding target embeddings that are closest to the adapted query embedding according to a similarity measure. For example, the system can perform a k-nearest neighbor search of the target embeddings using the adapted query embedding. In another example, the system can perform a search to identify one or more target items that have corresponding adapted target item embeddings that are closest to the adapted query embedding according to the similarity measure. For example, the system can perform a k-nearest neighbor search of the adapted target item embeddings using the adapted query embedding.

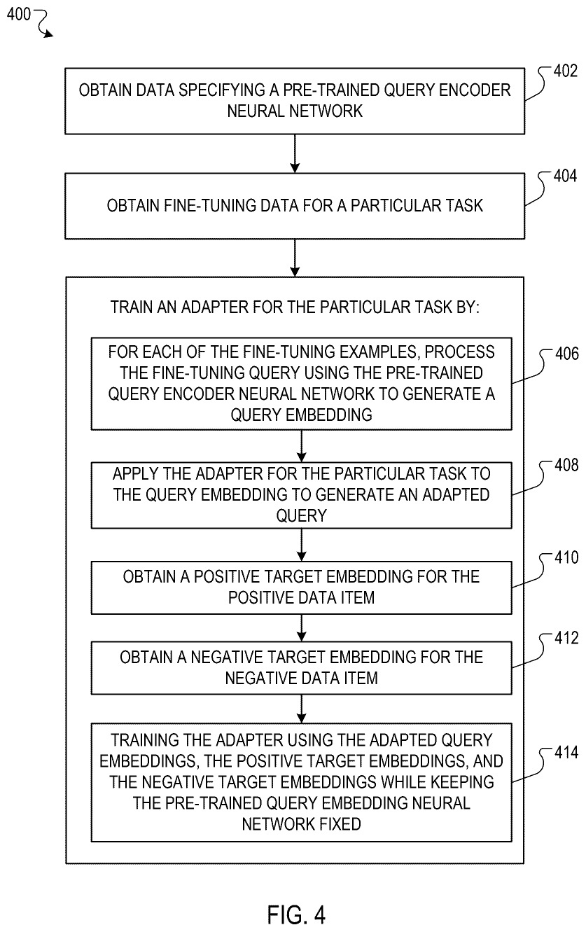

FIG. 4 is a flow diagram of an example process for training one or more neural networks to generate data item embeddings and to select the data item output from the generated data item embeddings. For convenience, the process 400 will be described as being performed by a system. For example, a system, e.g., the training system 102 of FIG. 1, appropriately configured in accordance with this specification, can perform the process 400.

The system can obtain data specifying a pre-trained query encoder neural network (402). For example, the system can receive data associated with the parameters of the pre-trained query encoder neural network.

The system can obtain fine-tuning data for a particular task (404). The fine-tuning data includes multiple fine-tuning examples, where each fine-tuning example includes a fine-tuning query, a positive target data item, and a negative target data item. The positive target data item is a correct item to be selected given the fine-tuning query, and the negative target data item is an incorrect item that should not be selected given the fine-tuning query.

In some examples, the system can generate more fine-tuning examples by using a language model to generate a respective positive target data item and a respective negative target data item. In this case, the system can process an input that includes the query and a prompt that instructs the language model to generate a positive target data item according to a specification for the particular task using the language model. In some cases, the system can also process a second input that includes the query and a prompt that instructs the language model to generate a negative target data item according to the specification for the particular task. In some other cases, the input can include the query, the prompt for generating the positive target data item, and the prompt for generating the negative target data item, such that the language model generates both the positive target data item and the negative target data item.

The system can then train an adapter for the particular task. In particular, for each fine-tuning example, the system can process the fine-tuned query using the pre-trained query encoder neural network to generate a query embedding (406).

The system can then apply the adapter for the particular task to the query embedding to generate an adapted query (408). Optionally, prior to training the adapter, the system can initialize the adapter as an identity transformation, such that the adapter is a projection matrix. The system can apply the adapter by multiplying the query embedding by the projection matrix.

The system can obtain a positive target embedding for the positive data item (410) and a negative target embedding for the negative data item (412). In particular, the system can process the positive target data item and the negative target data item using a pre-trained item encoder neural network to generate the positive target embedding and the negative target embedding.

In some examples, the system can apply the adapter for the particular task to the positive target embedding and the negative target embedding to generate an adapted positive target embedding and an adapted negative target embedding.

The system can train the adapter using the adapted query embeddings, the positive target embeddings, and the negative target embeddings while keeping the pre-trained query embedding neural network fixed (414).

In some other examples, the system can train the adapter using the adapted query embeddings, the positive target embeddings, and the negative target embeddings for the fine-tuning examples while keeping the pre-trained query encoder neural network and the pre-trained item encoder neural network fixed.

In particular, the system can train the adapter on a loss function that includes a contrastive loss. In some cases, the loss function also includes a regularization loss. The system can train the adapter using the loss function by updating the entries of the projection matrix.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible storage medium, which may be non-transitory, for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
maintaining a respective target embedding for each of a plurality of target data items;
receiving a new query for a particular task;
processing the new query using a query encoder neural network to generate a query embedding of the new query;
applying a learned adapter for the particular task to the query embedding to generate an adapted query embedding for the new query for the particular task; and
selecting, as a relevant target data item for the new query, one or more of the target data items using the adapted query embedding for the new query and the target embeddings for the target data items.

2. The method of claim 1, wherein each target data item comprises: text, an image, a video, an audio signal, or a combination thereof.

3. The method of claim 1, wherein the new query comprises: text, an image, a video, an audio signal, or a combination thereof.

4. The method of claim 1, further comprising:
generating the respective target embedding for each of a plurality of target items, comprising:
processing the target item using an item encoder neural network to generate an initial target item embedding of the target item.

5. The method of claim 4, wherein generating the respective target embedding further comprises:
applying the learned adapter for the particular task to the initial target item embedding to generate an adapted target item embedding.

6. The method of claim 1, where selecting one or more of the target data items comprises:
performing a search to identify one or more target items that have target embeddings that are closest to the adapted query embedding according to a similarity measure.

7. A method performed by one or more computers, the method comprising:
obtaining data specifying a pre-trained query encoder neural network;
obtaining fine-tuning data for a particular task, the fine-tuning data comprising a plurality of fine-tuning examples, each fine-tuning example comprising a fine-tuning query, a positive target data item, and a negative target data item; and
training an adapter for the particular task, the training comprising:
for each of the plurality of fine-tuning examples:
processing the fine-tuning query using the pre-trained query encoder neural network to generate a query embedding of the fine-tuning query;
applying the adapter for the particular task to the query embedding to generate an adapted query embedding for the fine-tuning query for the particular task;
obtaining a positive target embedding for the positive target data item; and
obtaining a negative target embedding for the negative target data item; and
training the adapter using the adapted query embeddings, the positive target embeddings, and the negative target embeddings for the fine-tuning examples while keeping the pre-trained query encoder neural network fixed.

8. The method of claim 7, wherein obtaining the positive target embedding for the positive target data item and obtaining the negative target embedding for the negative target data item comprises:
processing the positive target data item and the negative target data item using a pre-trained item encoder neural network to generate the positive target embedding for the positive target data item and the negative target embedding for the negative target data item.

9. The method of claim 8, wherein processing the positive target data item and the negative target data item further comprises:
applying the adapter for the particular task to the positive target embedding and the negative target embedding to generate an adapted positive target embedding and an adapted negative target embedding.

10. The method of claim 9, wherein training the adapter using the adapted query embeddings, the positive target embeddings, and the negative target embeddings for the fine-tuning examples while keeping the pre-trained query encoder neural network fixed comprises:
training the adapter using the adapted query embeddings, the positive target embeddings, and the negative target embeddings for the fine-tuning examples while keeping the pre-trained query encoder neural network and the pre-trained item encoder neural network fixed.

11. The method of claim 7, wherein obtaining fine-tuning data for a particular task further comprises:
for each fine-tuning example, processing the fine-tuning query of the fine-tuning example using a language model to generate a respective positive target data item and a respective negative target data item of the fine-tuning example.

12. The method of claim 11, wherein processing the fine-tuning query of the fine-tuning example using the language model to generate the respective positive target data item and the respective negative target data item of the fine-tuning example further comprises:
processing an input that comprises the query and a prompt that instructs the language model to generate a positive target data item according to a specification for the particular task using the language model.

13. The method of claim 12, further comprising:
processing a second input that comprises the query and a prompt that instructs the language model to generate a negative data item according to the specification for the particular task using the language model.

14. The method of claim 7, wherein training the adapter using the adapted query embeddings, the positive target embeddings, and the negative target embeddings for the fine-tuning examples comprises:
training the adapter on a loss function that comprises a contrastive loss.

15. The method of claim 13, wherein the loss function further comprises a regularization loss.

16. The method of claim 14, further comprising:
prior to the training, initializing the adapter as an identity transformation.

17. The method of claim 7, wherein the adapter is a projection matrix, and wherein applying the adapter comprises multiplying the query embedding by the projection matrix, and wherein the training comprises updating entries of the projection matrix.

18. The method of claim 7, wherein the positive target data item is a correct item to be selected given the fine-tuning query, and wherein the negative target data item is an incorrect item that should not be selected given the fine-tuning query.

19. The method of claim 7, wherein the positive target data item and the negative target data item each comprises: text, an image, a video, an audio signal, or a combination thereof.

20. The method of claim 7, wherein the fine-tuning query comprises: text, an image, a video, an audio signal, or a combination thereof.

21. A system comprising one or more computers and one or more storage devices storing instructions that are operable, when executed by the one or more computers, to cause the one or more computers to perform operations comprising:
maintaining a respective target embedding for each of a plurality of target data items;
receiving a new query for a particular task;
processing the new query using a query encoder neural network to generate a query embedding of the new query;
applying a learned adapter for the particular task to the query embedding to generate an adapted query embedding for the new query for the particular task; and
selecting, as a relevant target data item for the new query, one or more of the target data items using the adapted query embedding for the new query and the target embeddings for the target data items.

22. One or more computer storage media storing instructions that when executed by one or more computers cause the one or more computers to perform operations comprising:
maintaining a respective target embedding for each of a plurality of target data items; receiving a new query for a particular task;
processing the new query using a query encoder neural network to generate a query embedding of the new query;
applying a learned adapter for the particular task to the query embedding to generate an adapted query embedding for the new query for the particular task; and
selecting, as a relevant target data item for the new query, one or more of the target data items using the adapted query embedding for the new query and the target embeddings for the target data items.
